(19) United States
(12) Patent Application Publication
(10) Pub. No.: US 2008/0002436 A1
(43) Pub. Date: Jan. 3, 2008

(54) Christmas lamp with fastening device

(76) Inventor: Chi-Shih Lai, Taipei County (TW)

Correspondence Address: BACON & THOMAS, PLLC, 625 SLATERS LANE, FOURTH FLOOR, ALEXANDRIA, VA, 22314, US

(21) Appl. No.: 11/476,861

(22) Filed: Jun. 29, 2006

(51) Int. Cl. H01R 33/00

(52) U.S. Cl. 362/653

(57) ABSTRACT

One embodiment of Christmas lamp includes an LED bulb including two filament wires extended from its bottom; two power cords each having one end electrically connected to the filament wire and the other end electrically connected to a power source; a socket including a flexible clamp of C-section formed on its outer surface; and a holder including two opposite pairs of an upper trough and a lower groove; wherein the LED bulb is secured onto the holder with the filament wires received in the troughs and the power cords clamped by the grooves, and the assembled LED bulb and the holder are fastened in the socket with the LED bulb projected from a top of the socket. The invention has a number of other embodiments.

### BACKGROUND OF THE INVENTION

1. Field of Invention

The present invention relates to lamps for decoration and more particularly to a Christmas lamp having a device for fastening to a rod, etc.

2. Related Art

Christmas lamps are well known. Conventionally, Christmas lamps are mounted on a ceiling, wall, tree or the like by wrapping, hanging, gluing, etc. However, the prior art fastening techniques suffered from several disadvantages. For example, rain may permeate the lamp to cause shock circuit or bring other undesired results (e.g., rust). Further, the fastening is not reliable. That is, the lamp may displace or become loose. Furthermore, mounting a lamp or detaching same is a time consuming task. Thus, the need for improvement still exists.

### SUMMARY OF THE INVENTION

It is therefore an object of the present invention to provide a Christmas lamp comprising an LED (light-emitting diode) bulb including two filament wires extended from its bottom; two power cords each having one end electrically connected to the filament wire and the other end electrically connected to a power source; a socket including a flexible clamp of C-section formed on its outer surface; and a holder including two opposite pairs of an upper trough and a lower groove; wherein the LED bulb is secured onto the holder with the filament wires received in the troughs and the power cords clamped by the grooves, and the assembled LED bulb and the holder are fastened in the socket with the LED bulb projected from a top of the socket.

In one aspect of the present invention the socket further comprises a second clamp of C-section formed on its outer surface, the second clamp being disposed opposite the clamp and being disposed perpendicular thereto.

In another aspect of the present invention the second clamp comprises two bent fingers at one side and a bent finger at the other side.

In a further aspect of the present invention the socket further comprises a second clamp of C-section formed on its outer surface, the second clamp being disposed opposite the clamp.

It is another object of the present invention to provide a Christmas lamp comprising an LED bulb including two filament wires extended from its bottom; two power cords each having one end electrically connected to the filament wire and the other end electrically connected to a power source; a socket including a curved, flexible clamp formed on its outer surface; and a holder including two opposite pairs of an upper trough and a lower groove; wherein the LED bulb is secured onto the holder with the filament wires received in the troughs and the power cords clamped by the grooves, and the assembled LED bulb and the holder are fastened in the socket with the LED bulb projected from a top of the socket.

The above and other objects, features and advantages of the present invention will become apparent from the following detailed description taken with the accompanying drawings.

### BRIEF DESCRIPTION OF THE DRAWINGS

FIG. 1 is a perspective view of a first preferred embodiment of Christmas lamp according to the invention;

FIG. 2 is an exploded view of the lamp;

FIG. 3 is a longitudinal sectional view of the lamp;

FIG. 4 is an environmental view of two lamps being mounted in series on a rod;

FIG. 5 is an environmental view of two Christmas lamps according to a second preferred embodiment of the invention being mounted in series on a rod;

FIG. 6 is an environmental view of two Christmas lamps according to a third preferred embodiment of the invention being mounted in series in lattices;

FIG. 7 is a perspective view of a fourth preferred embodiment of Christmas lamp according to the invention; and

FIG. 8 is an environmental view of a Christmas lamp according to a fifth preferred embodiment of the invention being mounted on a rod.

### DETAILED DESCRIPTION OF THE INVENTION

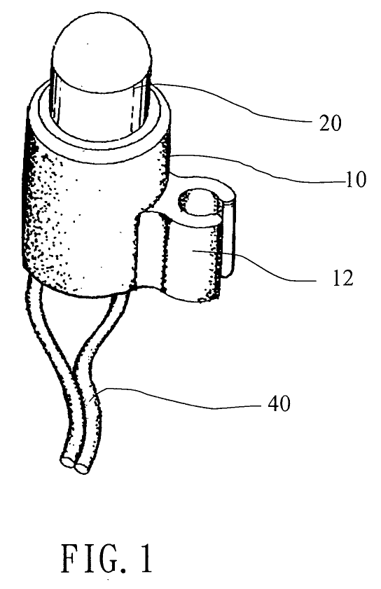

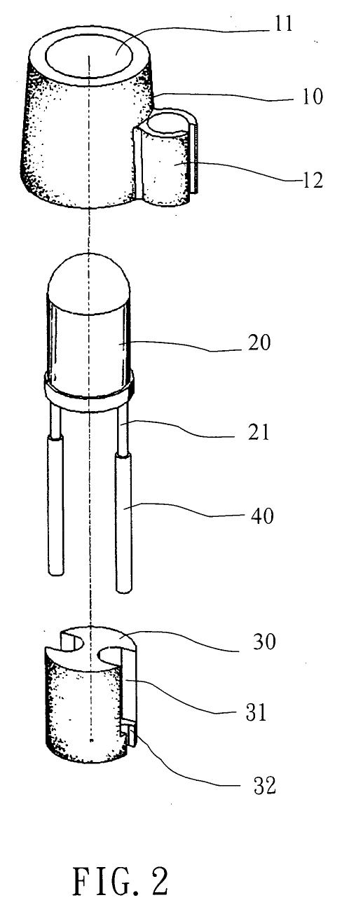

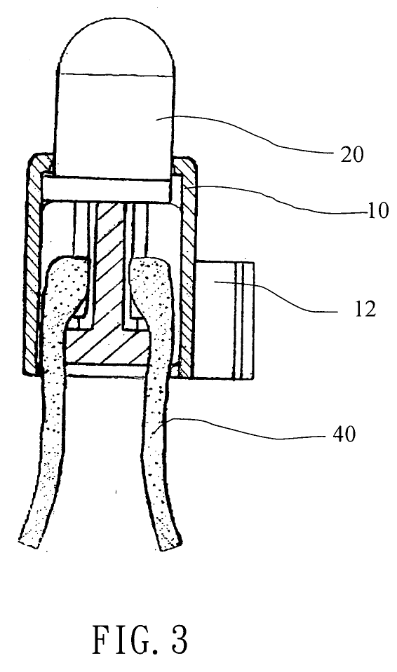

Referring to FIGS. 1 to 4, a Christmas lamp in accordance with a first preferred embodiment of the invention comprises an LED (light-emitting diode) bulb 20 including two filament wires 21 extended from its bottom; two shielded electric wires 40 each having one end electrically connected to the filament wire 21; a cylindrical socket 10 including a central channel 11 and an elongated flexible clamp 12 of C-section longitudinally formed on its outer surface; and a cylindrical holder 30 including two opposite pairs of an upper trough 31 and a lower groove 32 having a length much smaller than that of the trough 31.

An assembly of the invention will be described in detailed below. Insert the filament wires 21 and the electric wires 40 through the troughs 31 and the grooves 32 until a bottom of the bulb 20 is stopped by a top of the holder 30. At this position, the filament wires 21 are received in the troughs 31 and the electric wires 40 are clamped by the grooves 32. Next, insert the assembled bulb 20 and holder 30 through the channel 11 from a bottom of the socket 10 until an annular bottom flange of the bulb 20 is stopped by an annular inward extending top rim of the socket 10.

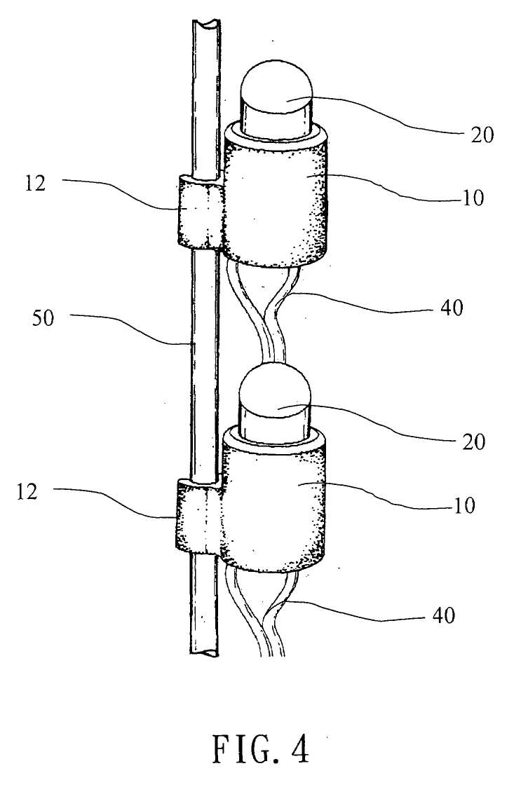

As shown in FIG. 4, two Christmas lamps of the invention are mounted in series on a rod 50 by inserting the rod 50 through the clamps 12. Also, the lamps are electrically connected in series.

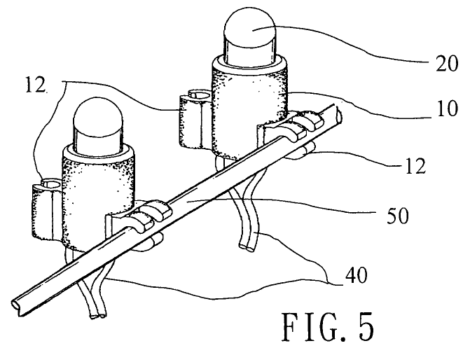

Referring to FIG. 5, a Christmas lamp according to a second preferred embodiment of the invention is shown. The characteristics of the second preferred embodiment are detailed below. A second clamp 12 of C-section is formed on the outer surface of the socket 10. The second clamp 12 is disposed opposite the clamp 12 and is disposed perpendicular thereto. Further, the second clamp 12 has two bent fingers at one side and a bent finger at the other side. In mounting, two Christmas lamps of the invention are mounted in series on a rod 50 by inserting the rod 50 through the second clamps 12.

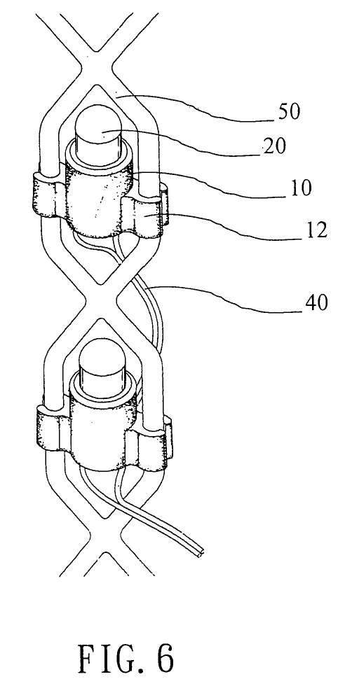

Referring to FIG. 6, a Christmas lamp according to a third preferred embodiment of the invention is shown. The characteristics of the third preferred embodiment are detailed below. A second clamp 12 of C-section is formed on the outer surface of the socket 10. The second clamp 12 is disposed opposite the clamp 12 and is disposed in parallel therewith. In mounting, a first bar 50 is inserted through the clamp 12 of one Christmas lamp and the second clamp 12 of the other Christmas lamp, and a second bar 50 is inserted through the second clamp 12 of one Christmas lamp and the clamp 12 of the other Christmas lamp. The bars 50 are bent and crossed each other to form lattices with the lamps being fastened therein.

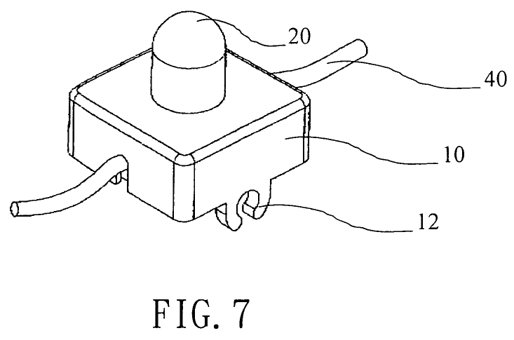

Referring to FIG. 7, a Christmas lamp according to a fourth preferred embodiment of the invention is shown. The characteristics of the fourth preferred embodiment are detailed below. The socket 10 is a rectangular member having front and rear cuts with the electric wires 40 passed. Two opposite clamps 12 are formed at two bottom sides of the socket 10. The clamp 12 is of C-shaped.

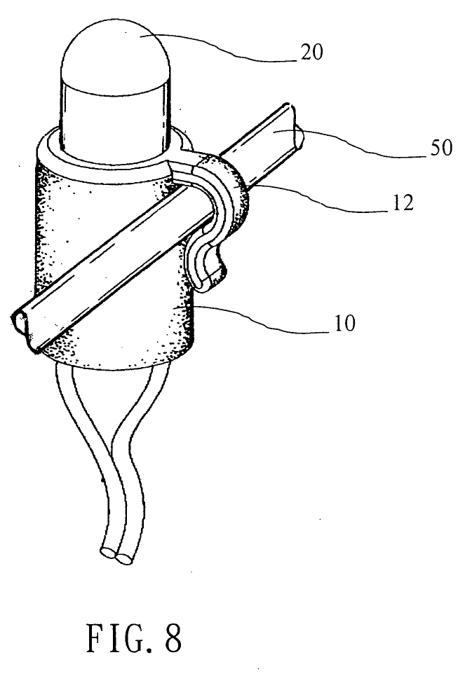

Referring to FIG. 8, a Christmas lamp according to a fifth preferred embodiment of the invention is shown. The characteristics of the fifth preferred embodiment are detailed below. The clamp 12 has one end integrally formed with a top edge of the socket 10. The clamp 12 is shaped as a bent handle. In mounting, a bar 50 passes a tunnel defined by the clamp 12 and is thus fastened.

The Christmas lamp of the invention has advantages of being easy in assembly or disassembly. Further, the fastening by the clamp is reliable. Furthermore, probability of leaking current is very low.

While the invention herein disclosed has been described by means of specific embodiments, numerous modifications and variations could be made thereto by those skilled in the art without departing from the scope and spirit of the invention set forth in the claims.

What is claimed is:

1. A lamp comprising:
an LED (light-emitting diode) bulb including two filament wires extended from its bottom;
two power cords each having one end electrically connected to the filament wire and the other end electrically connected to a power source;
a socket including a flexible clamp of C-section formed on its outer surface; and
a holder including two opposite pairs of an upper trough and a lower groove;
wherein the LED bulb is secured onto the holder with the filament wires received in the troughs and the power cords clamped by the grooves, and the assembled LED bulb and the holder are fastened in the socket with the LED bulb projected from a top of the socket.

2. The lamp of claim 1, wherein the socket further comprises a second clamp of C-section formed on its outer surface, the second clamp being disposed opposite the clamp and being disposed perpendicular thereto.

3. The lamp of claim 2, wherein the second clamp comprises two bent fingers at one side and a bent finger at the other side.

4. The lamp of claim 1, wherein the socket further comprises a second clamp of C-section formed on its outer surface, the second clamp being disposed opposite the clamp.

5. A lamp comprising:
an LED bulb including two filament wires extended from its bottom;
two power cords each having one end electrically connected to the filament wire and the other end electrically connected to a power source;
a socket including a curved, flexible clamp formed on its outer surface; and
a holder including two opposite pairs of an upper trough and a lower groove;
wherein the LED bulb is secured onto the holder with the filament wires received in the troughs and the power cords clamped by the grooves, and the assembled LED bulb and the holder are fastened in the socket with the LED bulb projected from a top of the socket.
